(19) United States
(12) Patent Application Publication
(10) Pub. No.: US 2026/0331720 A1
(43) Pub. Date: Oct. 22, 2026

(54) CURRENT COLLECTOR AND CYLINDRICAL BATTERY CELL COMPRISING THE SAME

(71) Applicant: SK On Co., Ltd., Seoul (KR)

(72) Inventors: Jong Hun PARK, Daejeon (KR); Byung Mook KIM, Daejeon (KR); Mi So RHO, Daejeon (KR); Kyung Tae PARK, Daejeon (KR); Byeong Hyeon PARK, Daejeon (KR); Yong Seok LEE, Daejeon (KR)

(21) Appl. No.: 19/653,120

(22) Filed: Apr. 21, 2026

(30) Foreign Application Priority Data
Apr. 21, 2025 (KR) 10-2025-0051663

(51) Int. Cl. H01M 50/536; H01M 10/04; H01M 50/107; H01M 50/533; H01M 50/545

(52) U.S. Cl. CPC H01M 50/536; H01M 10/0422; H01M 50/107; H01M 50/533; H01M 50/545; H01M 2200/106

(57) ABSTRACT

A current collector and a cylindrical battery cell including the same are provided. The current collector includes an uncoated-portion contact portion, at least a portion of which is coupled to a first electrode uncoated portion of a first electrode of an electrode assembly of the cylindrical battery cell such that the uncoated-portion contact portion is electrically connected to the first electrode, and a can contact portion coupled to the uncoated-portion contact portion to be electrically connected thereto, at least a portion of which contacts an inner circumferential surface of a can of the cylindrical battery cell such that the can contact portion is electrically connected to the can. The uncoated-portion contact portion includes the same material as the first electrode uncoated portion, and the can contact portion includes the same material as the can.

### CROSS-REFERENCE TO RELATED PATENT APPLICATIONS

The present disclosure claims priority under 35 U.S.C. § 119(a) to Korean patent application number 10-2025-0051663, filed on Apr. 21, 2025, the entire disclosure of which is incorporated herein by reference.

### BACKGROUND OF THE INVENTION

### 1. Field

Various embodiments of the present disclosure generally relate to a current collector and a cylindrical battery cell comprising the same, and more particularly, to a current collector capable of being effectively welded to an uncoated portion and a can and a cylindrical battery cell comprising the current collector.

### 2. Description of the Related Art

A cylindrical battery cell may be configured such that an electrode assembly including a first electrode and a second electrode therein is accommodated in a can serving as a case, and the can is electrically connected to the first electrode and an electrode terminal is electrically connected to the second electrode.

To electrically connect the first electrode to a current collector, a first electrode uncoated portion, which is a portion of the first electrode not coated with a first electrode active material layer, may be coupled to the current collector by welding or the like, and a portion of the current collector may be coupled to an inner circumferential surface of the can by welding or the like.

The first electrode uncoated portion or the second electrode uncoated portion generally includes copper, while the can includes aluminum or the like. That is, the electrode uncoated portion and the can include different metals.

Two members including different metals are not easy to weld, and since a current collector included in a cylindrical battery cell is conventionally formed of a single metal, it is difficult to weld a can and an electrode uncoated portion including different metals to the current collector including a single metal.

Accordingly, when the welding between the current collector and the can is not effectively accomplished, or when the welding between the current collector and the electrode uncoated portion is not effectively accomplished, the electrode uncoated portion may be spaced apart from the current collector or the current collector may be spaced apart from the can, and an electrode and the can might not be electrically connected, causing the battery cell to fail to supply power.

Accordingly, there is a need to develop a current collector capable of being easily welded to both an electrode uncoated portion and a can, and a cylindrical battery cell comprising such a current collector.

### SUMMARY OF THE INVENTION

An object of the present disclosure is to provide a current collector capable of being easily welded to an electrode uncoated portion and a can, and a cylindrical battery cell comprising the current collector.

Another object of the present disclosure is to provide the current collector capable of ensuring the safety of a battery cell by reducing a flow of current when the temperature rises, and the cylindrical battery cell comprising the current collector.

The current collector and the cylindrical battery cell comprising the same according to the present disclosure can be widely applied in the green technology fields using batteries such as electric vehicles. Furthermore, the current collector and the cylindrical battery cell comprising the same according to the present disclosure may be used for eco-friendly electric vehicles, hybrid vehicles, and the like, to reduce air pollution and greenhouse gas emissions to prevent or mitigate climate change.

According to an embodiment of the present disclosure, a current collector of a cylindrical battery cell may include an uncoated-portion contact portion and a can contact portion. At least a portion of the uncoated-portion contact portion may be coupled to a first electrode uncoated portion of a first electrode of an electrode assembly of the cylindrical battery cell such that the uncoated-portion contact portion is electrically connected to the first electrode. The can contact portion may be coupled to the uncoated-portion contact portion to be electrically connected thereto. At least a portion of the can contact portion may contact an inner circumferential surface of a can of the cylindrical battery cell such that the can contact portion is electrically connected to the can. The uncoated-portion contact portion may include the same material as the first electrode uncoated portion, and the can contact portion may include the same material as the can.

In an embodiment, the uncoated-portion contact portion may include a current collecting member including an upper surface, a lower surface, and a side surface connecting the upper surface and the lower surface. The can contact portion may include a first coupling member having a hollow columnar shape extending in a longitudinal direction. The first coupling member may be coupled to an outer peripheral edge of the current collecting member to protrude from the outer peripheral edge of the current collecting member in a direction away from the upper surface.

In an embodiment, one end of the first coupling member in the longitudinal direction may be coupled to an outer peripheral edge of the upper surface.

In an embodiment, an inner circumferential surface of the first coupling member may be coupled to the side surface.

In an embodiment, the uncoated-portion contact portion may further include a reinforcing member having a hollow columnar shape protruding from an outer peripheral edge of the upper surface in the direction away from the upper surface, and an inner circumferential surface of the first coupling member may be coupled to the side surface and to an outer circumferential surface of the reinforcing member.

In an embodiment, the uncoated-portion contact portion may include a current collecting member including an upper surface, a lower surface, and a side surface connecting the upper surface and the lower surface. The can contact portion may include a first coupling member having a hollow columnar shape extending in a longitudinal direction and a second coupling member including a first surface, a second surface, and a third surface connecting the first surface and the second surface. The second surface of the second coupling member may be coupled to the upper surface of the current collecting member. The first coupling member may extend from an outer peripheral edge of the second coupling member to protrude therefrom in a direction away from the first surface.

In an embodiment, the uncoated-portion contact portion may further include one or more height adjustment members extending from the lower surface to form an acute angle with the lower surface, and the first electrode uncoated portion may be coupled to the height adjustment member.

According to an embodiment of the present disclosure, a current collector of a cylindrical battery cell may include an uncoated-portion contact portion, a can contact portion, and a variable resistance portion. At least a portion of the uncoated-portion contact portion may be coupled to a first electrode uncoated portion of a first electrode of an electrode assembly of the cylindrical battery cell such that the uncoated-portion contact portion is electrically connected to the first electrode. The can contact portion may be coupled to the uncoated-portion contact portion to be electrically connected thereto. At least a portion of the can contact portion contacts an inner circumferential surface of a can of the cylindrical battery cell such that the can contact portion is electrically connected to the can. The variable resistance portion may include a Positive Temperature Coefficient (PTC) material having a resistance that increases by a predetermined magnitude or more when a temperature reaches or exceeds a predetermined temperature. The variable resistance portion may be disposed at a portion at which the uncoated-portion contact portion and the can contact portion are coupled such that a portion of the variable resistance portion contacts the uncoated-portion contact portion and a remaining portion thereof contacts the can contact portion. The can contact portion may include the same material as the can and the uncoated-portion contact portion includes the same material as the first electrode uncoated portion.

In an embodiment, the uncoated-portion contact portion may include a current collecting member including an upper surface, a lower surface, and a side surface connecting the upper surface and the lower surface. The can contact portion may include a first coupling member having a hollow columnar shape extending in a longitudinal direction. The first coupling member may be coupled to an outer peripheral edge of the current collecting member with the variable resistance portion interposed therebetween such that the first coupling member protrudes from the outer peripheral edge of the current collecting member in a direction away from the upper surface.

In an embodiment, one end of the first coupling member in the longitudinal direction may be coupled to an outer peripheral edge of the upper surface with the variable resistance portion interposed therebetween.

In an embodiment, an inner circumferential surface of the first coupling member may be coupled to the side surface with the variable resistance portion interposed therebetween.

In an embodiment, the uncoated-portion contact portion may further include a reinforcing member having a hollow columnar shape protruding from an outer peripheral edge of the upper surface in the direction away from the upper surface, and an inner circumferential surface of the first coupling member may be coupled to the side surface and to an outer circumferential surface of the reinforcing member with the variable resistance portion interposed therebetween.

In an embodiment, the uncoated-portion contact portion may include a current collecting member including an upper surface, a lower surface, and a side surface connecting the upper surface and the lower surface. The can contact portion may include a first coupling member having a hollow columnar shape extending in a longitudinal direction, and a second coupling member including a first surface, a second surface, and a third surface connecting the first surface and the second surface. The second surface of the second coupling member may be coupled to the upper surface of the current collecting member with the variable resistance portion interposed therebetween. The first coupling member may extend from an outer peripheral edge of the second coupling member to protrude therefrom in a direction away from the first surface.

In an embodiment, the uncoated-portion contact portion may further include one or more height adjustment members extending from the lower surface to form an acute angle with the lower surface, and the first electrode uncoated portion may be coupled to the height adjustment member.

According to an embodiment of the present disclosure, a cylindrical battery cell may include an electrode assembly; a can having a cylindrical shape, having an accommodation space formed therein, and accommodating the electrode assembly in the accommodation space through an opening formed at one side thereof; a current collector; a cap covering the opening to seal the accommodation space; and an electrode terminal installed at one side of the can to be insulated from the can, and electrically connected to the plurality of second electrodes. The electrode assembly may include a plurality of first electrodes including a first electrode uncoated portion in which a first electrode active material layer is not formed, and a plurality of second electrodes alternately stacked with the plurality of first electrodes with a separator interposed therebetween.

According to embodiments of the present disclosure, a current collector is configured such that an uncoated-portion contact portion includes the same material as an electrode uncoated portion, and a can contact portion includes the same material as a can, thereby facilitating welding of the uncoated-portion contact portion to the electrode uncoated portion and the can contact portion to the can.

Furthermore, a variable resistance portion including a Positive Temperature Coefficient (PTC) material is disposed at a portion at which the uncoated-portion contact portion and the can contact portion are coupled, and reduces an amount of a flow of current when the temperature rises, thereby preventing or mitigating the temperature of the current collector from continuously rising.

In addition, in a cylindrical battery cell according to the present disclosure, the current collector is stably welded to the electrode uncoated portion and the can, thereby capable of stably supplying power to an external device.

Furthermore, the current collector includes the variable resistance portion, and thus the temperature of the current collector is prevented or mitigated from continuously rising, thereby preventing or mitigating the cylindrical battery cell from thermal runaway.

### BRIEF DESCRIPTION OF THE DRAWINGS

FIG. 1 is a cross-sectional view illustrating a current collector according to a first embodiment of the present disclosure, disposed in a cylindrical battery cell;

FIG. 2 is a perspective view illustrating an example of the current collector according to the first embodiment;

FIG. 3 is a cross-sectional view illustrating a state in which a current collecting member and a first coupling member of the current collector of FIG. 2 are coupled;

FIG. 4 is a cross-sectional view illustrating another state in which the current collecting member and the first coupling member of the current collector of FIG. 2 are coupled;

FIG. 5 is a perspective view illustrating another example of the current collector according to the first embodiment;

FIG. 6 is a cross-sectional view illustrating a state in which a current collecting member and a reinforcing member are coupled to a first coupling member in the current collector of FIG. 5;

FIG. 7 is a perspective view illustrating still another example of the current collector according to the first embodiment;

FIG. 8 is a cross-sectional view illustrating a state in which a current collecting member and a first coupling member are coupled to a second coupling member in the current collector of FIG. 7;

FIG. 9 is a cross-sectional view illustrating the current collector according to the first embodiment, including a height adjustment member;

FIG. 10 is a cross-sectional view illustrating the current collector of FIG. 9, disposed in the cylindrical battery cell;

FIG. 11 is a cross-sectional view illustrating a current collector according to a second embodiment of the present disclosure, disposed in a cylindrical battery cell;

FIG. 12 is a cross-sectional view illustrating a state in which a current collecting member and a first coupling member are coupled with a variable resistance portion interposed therebetween, as an example of the current collector according to the second embodiment of the present disclosure;

FIG. 13 is a cross-sectional view illustrating another state in which the current collecting member and the first coupling member are coupled with the variable resistance portion interposed therebetween, as an example of the current collector according to the second embodiment of the present disclosure;

FIG. 14 is a cross-sectional view illustrating a state in which a current collecting member and a reinforcing member are coupled to a first coupling member with a variable resistance portion interposed therebetween, as another example of the current collector according to the second embodiment;

FIG. 15 is a cross-sectional view illustrating a state in which a current collecting member and a first coupling member are coupled to a second coupling member with a variable resistance portion interposed therebetween, as still another example of the current collector according to the second embodiment; and

FIG. 16 is a cross-sectional view illustrating the current collector according to the second embodiment, including a height adjustment member.

### DETAILED DESCRIPTION

Hereinafter, embodiments of the present disclosure will be described in detail with reference to the accompanying drawings so that those skilled in the art can easily implement the embodiments. However, the present disclosure may be implemented in various different forms and is not limited to the embodiments described herein. In addition, in order to clearly explain the present disclosure in the drawings, parts irrelevant to the description have been omitted, and similar reference numerals have been given to similar elements throughout the specification.

Throughout this specification, when a part is "connected" to another part, this includes not only "directly connected" but also "electrically connected" with another element interposed therebetween.

Throughout this specification, when a member is "on" another member, this includes not only when the member is in contact with the other member, but also when there is another member between the two members.

Throughout this specification, when a part "includes," or "comprise" a certain component, it means that other components may be further included, rather than excluding other components, unless otherwise specified. The terms "about," "substantially," and the like, used throughout this specification, are used in or near their numerical values when manufacturing and material tolerances inherent in the stated meaning are presented, and exact or absolute numerical values are used to aid in the understanding of this disclosure in order to prevent unfair exploitation of the stated disclosure by unscrupulous infringers. As used throughout this specification, the term "step" or "step of" does not mean "step for".

Hereinafter, embodiments of the present disclosure will be described in detail with reference to the accompanying drawings and the contents described below. However, the present disclosure is not limited to the embodiments described herein and may be embodied in other forms. Like reference numerals refer to like elements throughout the specification.

Hereinafter, a configuration of a current collector according to a first embodiment of the present disclosure will be described.

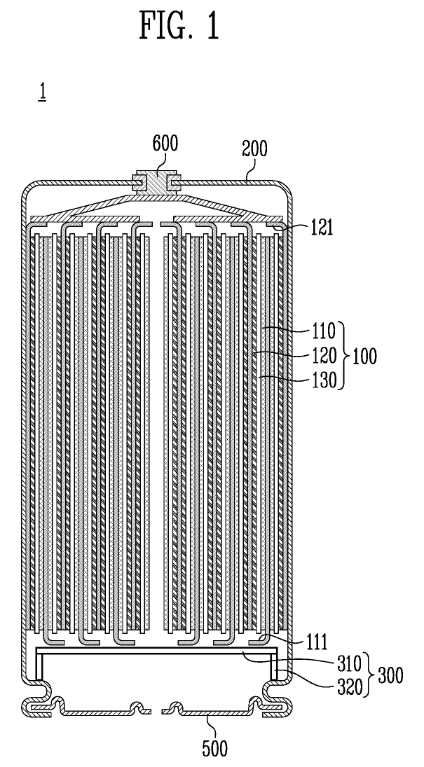

FIG. 1 is a cross-sectional view illustrating the current collector according to the first embodiment of the present disclosure, disposed in a cylindrical battery cell.

Referring to FIG. 1, a current collector 300 is the current collector 300 installed inside a cylindrical battery cell 1, and includes an uncoated-portion contact portion 310 and a can contact portion 320.

As shown in FIG. 1, at least a portion of the uncoated-portion contact portion 310 may be coupled to a first electrode uncoated portion 111 of a first electrode 110 of an electrode assembly 100 of the cylindrical battery cell 1 such that the uncoated-portion contact portion 310 is electrically connected to the first electrode 110.

For example, the uncoated-portion contact portion 310 may be coupled to the first electrode uncoated portion 111 by welding.

The uncoated-portion contact portion 310 may include the same material as the first electrode uncoated portion 111. For example, when the first electrode uncoated portion 111 includes copper, the uncoated-portion contact portion 310 may include copper.

By forming the uncoated-portion contact portion 310 as described above, the first electrode uncoated portion 111 may be easily welded to the uncoated-portion contact portion 310, and the uncoated-portion contact portion 310 and the first electrode uncoated portion 111 may be stably coupled.

Further, the can contact portion 320 may be coupled to the uncoated-portion contact portion 310 to be electrically connected thereto, and at least a portion of the can contact portion 320 may contact an inner circumferential surface of a can 200 of the cylindrical battery cell 1 such that the can contact portion 320 is electrically connected to the can 200.

For example, the can contact portion 320 may be coupled to the uncoated-portion contact portion 310 by welding, and the portion contacting the inner circumferential surface of the can 200 may be coupled to the can 200 by welding.

The can contact portion 320 may include the same material as the can 200. For example, when the can 200 includes aluminum, the can contact portion 320 may include aluminum.

By forming the can contact portion 320 as described above, the can contact portion 320 may be easily welded to the can 200, and the can contact portion 320 and the can 200 may be stably coupled.

The uncoated-portion contact portion 310 and the can contact portion 320 of the current collector 300 may be coupled in various structures.

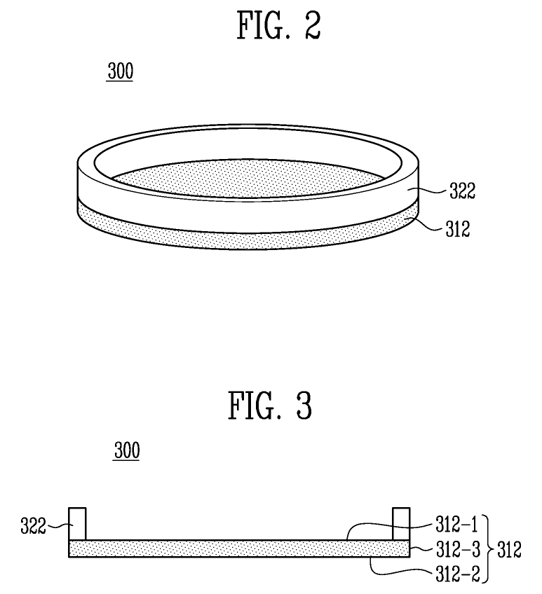

FIG. 2 is a perspective view illustrating an example of the current collector according to the first embodiment.

First, with reference to FIG. 2, the uncoated-portion contact portion 310 and the can contact portion 320 of the current collector 300 according to an example will be described.

As shown in FIG. 2, the uncoated-portion contact portion 310 includes a current collecting member 312, and the can contact portion 320 includes a first coupling member 322 and may be coupled to each other.

FIG. 3 is a cross-sectional view illustrating a state in which the current collecting member and the first coupling member of the current collector of FIG. 2 are coupled.

Specifically, with reference to FIG. 3, the current collecting member 312 may include an upper surface 312-1, a lower surface 312-2, and a side surface 312-3 connecting the upper surface 312-1 and the lower surface 312-2.

The first coupling member 322 may be coupled to the upper surface 312-1 of the current collecting member 312 configured as described above, such that the current collecting member 312 and the first coupling member 322 may be electrically connected, and the first electrode uncoated portion 111 may be coupled to the lower surface 312-2 of the current collecting member 312, such that the current collecting member 312 and the first electrode uncoated portion 111 may be electrically connected.

The first coupling member 322 may have a hollow columnar shape extending in a longitudinal direction, and may be coupled to an outer peripheral edge of the current collecting member 312 to protrude from the outer peripheral edge in a direction away from the upper surface 312-1.

For example, as shown in FIG. 3, one end of the first coupling member 322 in the longitudinal direction may be coupled to an outer peripheral edge of the upper surface 312-1 of the current collecting member 312.

A portion of the first coupling member 322 configured as described above, which protrudes in the direction away from the upper surface 312-1 of the current collecting member 312, may be coupled to the can 200, such that the first coupling member 322 and the can 200 may be electrically connected.

The current collector 300 according to an example, including the current collecting member 312 and the first coupling member 322 may have a different coupling structure between the current collecting member 312 and the first coupling member 322.

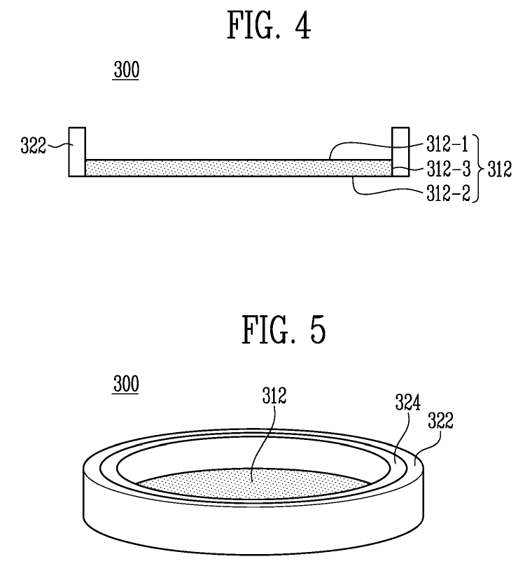

FIG. 4 is a cross-sectional view illustrating another state in which the current collecting member of the current collector of FIG. 2 and the first coupling member are coupled.

For example, as shown in FIG. 4, an inner circumferential surface of the first coupling member 322 may be coupled to the side surface 312-3 of the current collecting member 312.

FIG. 5 is a perspective view illustrating another example of the current collector according to the first embodiment.

Next, referring to FIG. 5, the uncoated-portion contact portion 310 and the can contact portion 320 of the current collector 300 according to another example will be described.

As shown in FIG. 5, the uncoated-portion contact portion 310 includes the current collecting member 312 and a reinforcing member 324, and the can contact portion 320 includes the first coupling member 322, such that the uncoated-portion contact portion 310 and the can contact portion 320 may be coupled to each other.

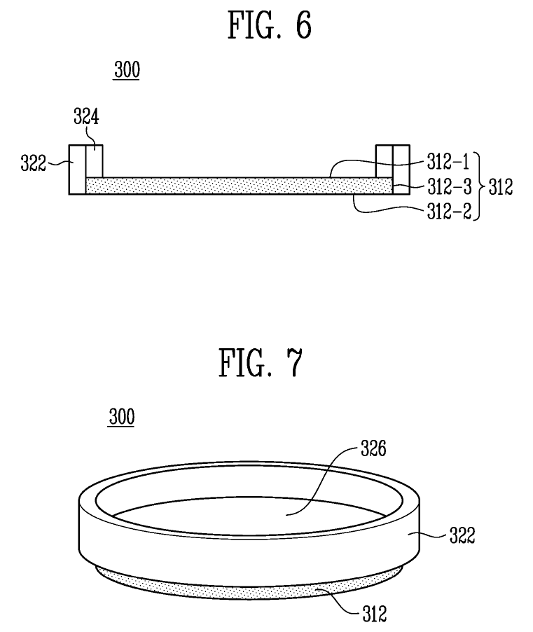

FIG. 6 is a cross-sectional view illustrating a state in which the current collecting member and the reinforcing member are coupled to the first coupling member in the current collector of FIG. 5.

Specifically, with reference to FIG. 6, the current collecting member 312 may include the upper surface 312-1, the lower surface 312-2, and the side surface 312-3 connecting the upper surface 312-1 and the lower surface 312-2.

The reinforcing member 324 may have a hollow columnar shape protruding from the outer peripheral edge of the upper surface 312-1 in the direction away from the upper surface 312-1.

As shown in FIG. 6, the inner circumferential surface of the first coupling member 322 may be coupled to the side surface 312-3 of the current collecting member 312 and an outer circumferential surface of the reinforcing member 324.

With the configuration as described above, the first electrode uncoated portion 111 may be coupled to the lower surface 312-2 of the current collecting member 312, such that the current collecting member 312 may be electrically connected to the first electrode uncoated portion 111, the reinforcing member 324 may be connected to the upper surface 312-1 of the current collecting member 312 and may be electrically connected to the current collecting member 312, and the first coupling member 322 may be coupled to the current collecting member 312 and the reinforcing member 324 and may be electrically connected to the current collecting member 312 and the reinforcing member 324.

Because the first coupling member 322 is coupled not only to the side surface 312-3 of the current collecting member 312 but also to the outer circumferential surface of the reinforcing member 324, the uncoated-portion contact portion 310 and the can contact portion 320 may be more firmly coupled.

FIG. 7 is a perspective view illustrating another example of a current collector according to a first embodiment.

Referring now to FIG. 7, the uncoated-portion contact portion 310 and the can contact portion 320 of the current collector 300 according to another example will be described.

As shown in FIG. 7, the uncoated-portion contact portion 310 includes the current collecting member 312, and the can contact portion 320 includes the first coupling member 322 and a second coupling member 326, such that the uncoated-portion contact portion 310 and the can contact portion 320 may be coupled to each other.

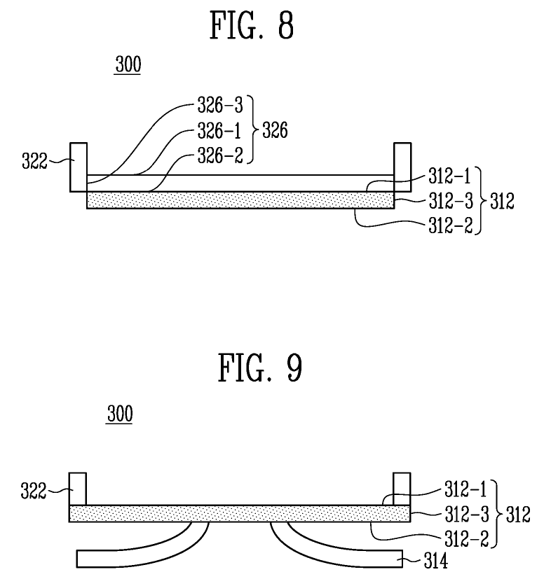

FIG. 8 is a cross-sectional view illustrating a state in which the current collecting member and the first coupling member are coupled to the second coupling member in the current collector of FIG. 7.

Specifically, with reference to FIG. 8, the current collecting member 312 may include the upper surface 312-1, the lower surface 312-2, and the side surface 312-3 connecting the upper surface 312-1 and the lower surface 312-2.

The first coupling member 322 may have a hollow columnar shape extending in the longitudinal direction.

The second coupling member 326 may include a first surface 326-1, a second surface 326-2, and a third surface 326-3 connecting the first surface 326-1 and the second surface 326-2, and the second surface 326-2 may be coupled to the upper surface 312-1 of the current collecting member 312.

The first coupling member 322 may extend from an outer peripheral edge of the second coupling member 326 to protrude therefrom in a direction away from the first surface 326-1.

In other words, the first coupling member 322 may be formed integrally with the second coupling member 326, or it may be formed separately from the second coupling member 326 and coupled thereto.

With the configuration as described above, the first electrode uncoated portion 111 may be coupled to the lower surface 312-2 of the current collecting member 312, such that the current collecting member 312 may be electrically connected to the first electrode uncoated portion 111, the second coupling member 326 may be coupled to the current collecting member 312 and may be electrically connected thereto, and the first coupling member 322 may be connected to and electrically connected to the second coupling member 326.

Because the second surface 326-2 of the second coupling member 326 and the upper surface 312-1 of the current collecting member 312 are coupled while a relatively large area is in contact, the uncoated-portion contact portion 310 and the can contact portion 320 may be stably coupled.

FIG. 9 is a cross-sectional view illustrating the current collector according to the first embodiment, including a height adjustment member.

Next, with reference to FIG. 9, the current collector 300 including a height adjustment member 314 will be described.

As shown in FIG. 9, the current collector 300 may include not only the current collecting member 312 and the first coupling member 322 but also one or more height adjustment members 314 extending from the lower surface 312-2 of the current collecting member 312 to form an acute angle with the lower surface 312-2.

The height adjustment member 314 as described above may include one or more of a straight shape and a curved shape, and the first electrode uncoated portion 111 may be coupled to the height adjustment member 314.

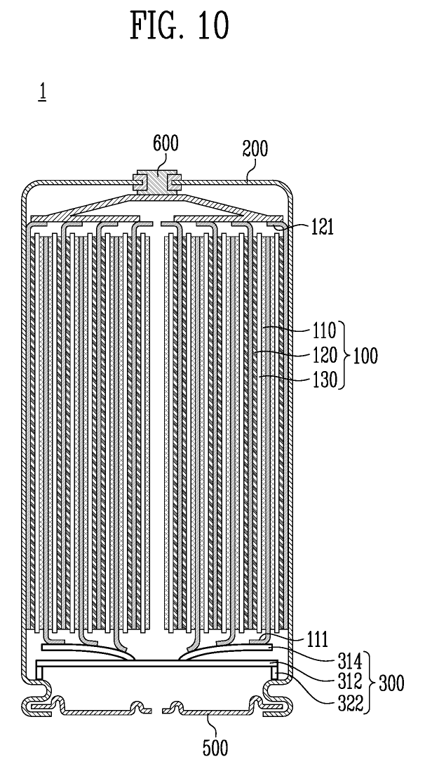

FIG. 10 is a cross-sectional view illustrating the current collector of FIG. 9, disposed in the cylindrical battery cell.

Specifically, as shown in FIG. 10, the first electrode uncoated portion 111 may be coupled to the current collector 300 including the height adjustment member 314.

When the distance between the first electrode uncoated portion 111 and the current collecting member 312 is relatively large, it might not be easy to directly couple the first electrode uncoated portion 111 to the current collecting member 312, considering the length of the first electrode uncoated portion 111.

Therefore, by coupling the first electrode uncoated portion 111 to the height adjustment member 314 extending from the current collecting member 312 toward the first electrode uncoated portion 111, the first electrode uncoated portion 111 and the current collecting member 312 may be easily electrically connected.

Hereinafter, a configuration of a current collector according to a second embodiment of the present disclosure will be described.

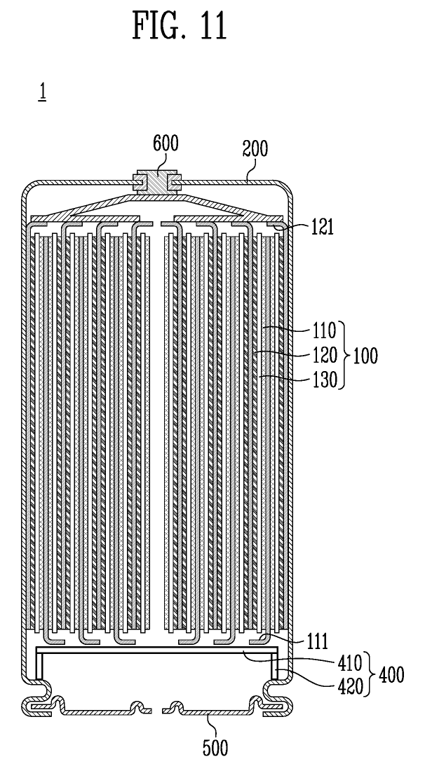

FIG. 11 is a cross-sectional view illustrating the current collector according to the second embodiment of the present disclosure, disposed in a cylindrical battery cell.

With reference to FIG. 11, a current collector 400 is the current collector 400 installed inside the cylindrical battery cell 1, and includes an uncoated-portion contact portion 410, a can contact portion 420, and a variable resistance portion 430.

As shown in FIG. 11, at least a portion of the uncoated-portion contact portion 410 may be coupled to the first electrode uncoated portion 111 of the first electrode 110 of the electrode assembly 100 of the cylindrical battery cell 1 such that the uncoated-portion contact portion 410 is electrically connected to the first electrode 110.

For example, the uncoated-portion contact portion 410 may be coupled to the first electrode uncoated portion 111 by welding.

The uncoated-portion contact portion 410 may include the same material as the first electrode uncoated portion 111. For example, when the first electrode uncoated portion 111 includes copper, the uncoated-portion contact portion 410 may include copper.

By forming the uncoated-portion contact portion 410 as described above, the first electrode uncoated portion 111 may be easily welded to the uncoated-portion contact portion 410, and the uncoated-portion contact portion 410 and the first electrode uncoated portion 111 may be stably coupled.

Further, the can contact portion 420 may be coupled to the uncoated-portion contact portion 410 to be electrically connected thereto, and at least a portion of the can contact portion 420 may contact the inner circumferential surface of the can 200 of the cylindrical battery cell 1 to be electrically connected to the can 200.

For example, the can contact portion 420 may be coupled to the uncoated-portion contact portion 410 by welding, and the portion contacting the inner circumferential surface of the can 200 may be coupled to the can 200 by welding.

The can contact portion 420 may include the same material as the can 200. For example, when the can 200 includes aluminum, the can contact portion 420 may include aluminum.

By forming the can contact portion 420 as described above, the can contact portion 420 may be easily welded to the can 200, and the can contact portion 420 and the can 200 may be stably coupled.

The variable resistance portion 430 may include a Positive Temperature Coefficient (PTC) material having the resistance that increases by a predetermined magnitude or more when the temperature reaches or exceeds a predetermined temperature.

The variable resistance portion 430 as described above may be disposed at a portion at which the uncoated-portion contact portion 410 and the can contact portion 420 are coupled such that a portion of the variable resistance portion 430 contacts the uncoated-portion contact portion 410 and a remaining portion thereof contacts the can contact portion 420.

In other words, the variable resistance portion 430 may serve to reduce the amount of current flowing between the uncoated-portion contact portion 410 and the can contact portion 420 as the resistance increases when the temperature increases.

Therefore, as the current collector 400 includes the variable resistance portion 430, the amount of current flowing through the current collector 400 may be reduced when the temperature of the current collector 400 rises, thereby preventing or mitigating the temperature of the current collector 400 from continuously rising.

The uncoated-portion contact portion 410, the can contact portion 420, and the variable resistance portion 430 of the current collector 400 may be coupled in various structures.

First, the uncoated-portion contact portion 410, the can contact portion 420, and the variable resistance portion 430 of the current collector 400 according to an example will be described.

The current collector 400 according to an example is identical in configuration to the current collector 300 according to an example, except that the variable resistance portion 430 is disposed therein.

That is, the uncoated-portion contact portion 410 includes a current collecting member 412, and the can contact portion 420 includes a first coupling member 422, such that the uncoated-portion contact portion 410 and the can contact portion 420 may be coupled to each other with the variable resistance portion 430 interposed therebetween.

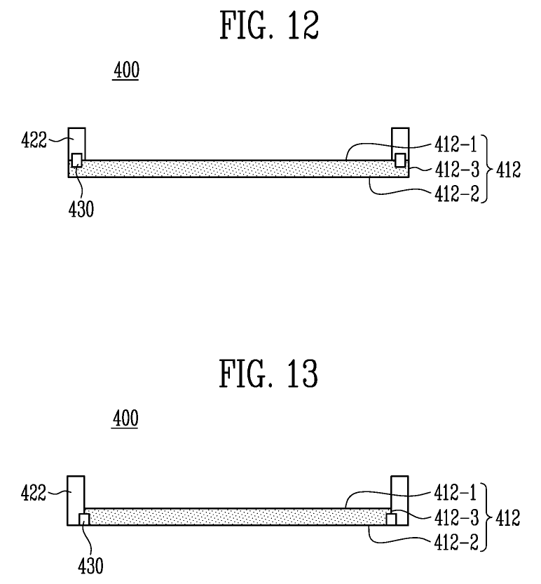

FIG. 12 is a cross-sectional view illustrating a state in which the current collecting member and the first coupling member are coupled with the variable resistance portion interposed therebetween, as an example of the current collector according to the second embodiment of the present disclosure.

Specifically, with reference to FIG. 12, the current collecting member 412 may include an upper surface 412-1, a lower surface 412-2, and a side surface 412-3 connecting the upper surface 412-1 and the lower surface 412-2.

The first coupling member 422 may be coupled to the upper surface 412-1 of the current collecting member 412 configured as described above, such that the current collecting member 412 and the first coupling member 422 may be electrically connected, and the first electrode uncoated portion 111 may be coupled to the lower surface 412-2 of the current collecting member 412, such that the current collecting member 412 and the first electrode uncoated portion 111 may be electrically connected.

The first coupling member 422 may have a hollow columnar shape extending in a longitudinal direction, and may be coupled to an outer peripheral edge of the current collecting member 412 with the variable resistance portion 430 interposed therebetween such that the first coupling member 422 protrudes from the outer peripheral edge of the current collecting member 412 in a direction away from the upper surface 412-1.

For example, as shown in FIG. 12, one end of the first coupling member 422 in the longitudinal direction may be coupled to an outer peripheral edge of the upper surface 412-1 of the current collecting member 412 with the variable resistance portion 430 interposed therebetween.

A portion of the first coupling member 422 configured as described above, which protrudes in the direction away from the upper surface 412-1 of the current collecting member 412, may be coupled to the can 200, such that the first coupling member 422 and the can 200 may be electrically connected, and the variable resistance portion 430 may be disposed between the current collecting member 412 and the first coupling member 422, such that the amount of current flowing between the current collecting member 412 and the first coupling member 422 may be reduced as the resistance increases when the temperature increases.

The current collector 400 according to an example, including the current collecting member 412 and the first coupling member 422 may have a different coupling structure between the current collecting member 412 and the first coupling member 422.

FIG. 13 is a cross-sectional view illustrating another state in which the current collecting member and the first coupling member are coupled with the variable resistance portion interposed therebetween, as an example of the current collector according to the second embodiment of the present disclosure.

For example, as shown in FIG. 13, an inner circumferential surface of the first coupling member 422 may be coupled to the side surface 412-3 of the current collecting member 412 with the variable resistance portion 430 interposed therebetween.

Next, the uncoated-portion contact portion 410, the can contact portion 420, and the variable resistance portion 430 of the current collector 400 according to another example will be described.

The current collector 400 according to another example is identical in configuration to the current collector 300 according to another example, except that the variable resistance portion 430 is disposed therein.

That is, the uncoated-portion contact portion 410 includes the current collecting member 412 and a reinforcing member 424, and the can contact portion 420 includes the first coupling member 422, such that the uncoated-portion contact portion 410 and the can contact portion 420 may be coupled to each other with the variable resistance portion 430 interposed therebetween.

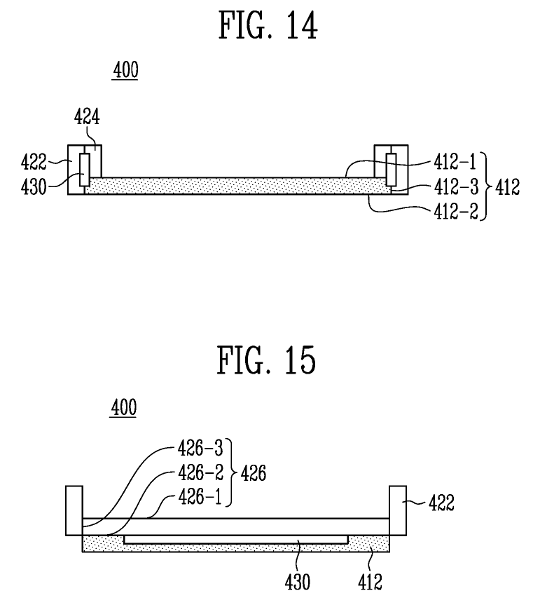

FIG. 14 is a cross-sectional view illustrating a state in which the current collecting member and the reinforcing member are coupled to the first coupling member with the variable resistance portion interposed therebetween, as another example of the current collector according to the second embodiment.

Specifically, with reference to FIG. 14, the current collecting member 412 may include the upper surface 412-1, the lower surface 412-2, and the side surface 412-3 connecting the upper surface 412-1 and the lower surface 412-2.

The reinforcing member 424 may have a hollow columnar shape protruding from the outer peripheral edge of the upper surface 412-1 in the direction away from the upper surface 412-1.

As shown in FIG. 14, the inner circumferential surface of the first coupling member 422 may be coupled to the side surface 412-3 of the current collecting member 412 and an outer circumferential surface of the reinforcing member 424 with the variable resistance portion 430 interposed therebetween.

With the configuration as described above, the first electrode uncoated portion 111 may be coupled to the lower surface 412-2 of the current collecting member 412, such that the current collecting member 412 may be electrically connected to the first electrode uncoated portion 111, the reinforcing member 424 may be connected to the upper surface 412-1 of the current collecting member 412 and may be electrically connected to the current collecting member 412, and the first coupling member 422 may be coupled to the current collecting member 412 and the reinforcing member 424 and may be electrically connected to the current collecting member 412 and the reinforcing member 424.

Further, the variable resistance portion 430 may be disposed between the current collecting member 412 and the reinforcing member 424 and the first coupling member 422, such that the amount of current flowing between the current collecting member 412 and the reinforcing member 424 and the first coupling member 422 may be reduced as the resistance increases when the temperature rises.

Because the first coupling member 422 is coupled not only to the side surface 412-3 of the current collecting member 412 but also to the outer circumferential surface of the reinforcing member 424, the uncoated-portion contact portion 410 and the can contact portion 420 may be more firmly coupled.

Next, the uncoated-portion contact portion 410, the can contact portion 420, and the variable resistance portion 430 of the current collector 400 according to still another example will be described.

The current collector 400 according to still another example is identical in configuration to the current collector 300 according to still another example, except that the variable resistance portion 430 is disposed therein.

That is, the uncoated-portion contact portion 410 includes the current collecting member 412, and the can contact portion 420 includes the first coupling member 422 and a second coupling member 426, such that the uncoated-portion contact portion 410 and the can contact portion 420 may be coupled to each other with the variable resistance portion 430 interposed therebetween.

FIG. 15 is a cross-sectional view illustrating a state in which the current collecting member and the first coupling member are coupled to the second coupling member with the variable resistance portion interposed therebetween, as still another example of the current collector according to the second embodiment.

Specifically, with reference to FIG. 15, the current collecting member 412 may include the upper surface 412-1, the lower surface 412-2, and the side surface 412-3 connecting the upper surface 412-1 and the lower surface 412-2.

The first coupling member 422 may have a hollow columnar shape extending in the longitudinal direction.

The second coupling member 426 may include a first surface 426-1, a second surface 426-2, and a third surface 426-3 connecting the first surface 426-1 and the second surface 426-2, and the second surface 426-2 may be coupled to the upper surface 412-1 of the current collecting member 412 with the variable resistance portion 430 interposed therebetween.

The first coupling member 422 may extend from an outer peripheral edge of the second coupling member 426 to protrude therefrom in a direction away from the first surface 426-1.

In other words, the first coupling member 422 may be formed integrally with the second coupling member 426, or it may be formed separately from the second coupling member 426 and coupled thereto.

With the configuration as described above, the first electrode uncoated portion 111 may be coupled to the lower surface 412-2 of the current collecting member 412, such that the current collecting member 412 may be electrically connected to the first electrode uncoated portion 111, the second coupling member 426 may be coupled to the current collecting member 412 and may be electrically connected thereto, and the first coupling member 422 may be connected and may be electrically connected to the second coupling member 426.

Further, the variable resistance portion 430 may be disposed between the current collecting member 412 and the second coupling member 426, such that the amount of current flowing between the current collecting member 412 and the second coupling member 426 may be reduced as the resistance increases when the temperature rises.

Because the second surface 426-2 of the second coupling member 426 and the upper surface 412-1 of the current collecting member 412 are coupled while a relatively large area is in contact, the uncoated-portion contact portion 410 and the can contact portion 420 may be stably coupled.

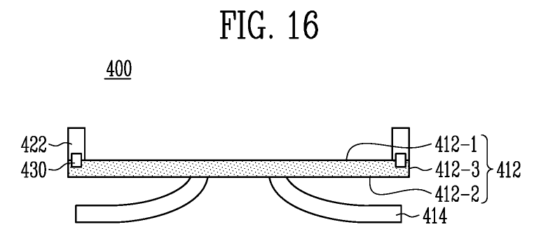

FIG. 16 is a cross-sectional view illustrating the current collector according to the second embodiment, including a height adjustment member.

Next, with reference to FIG. 16, the current collector 400 including a height adjustment member 414 will be described.

As shown in FIG. 16, the current collector 400 may include not only the current collecting member 412, the first coupling member 422, and the variable resistance portion 430, but also one or more height adjustment members 414 extending from the lower surface 412-2 of the current collecting member 412 to form an acute angle with the lower surface 412-2.

The height adjustment member 414 as described above may include one or more of a straight shape and a curved shape, and the first electrode uncoated portion 111 may be coupled to the height adjustment member 414.

Because the structure and effect of the current collector 400 including the height adjustment member 414 being disposed in the cylindrical battery cell 1 is the same as those of the current collector 300 including the height adjustment member 314 being disposed in the cylindrical battery cell 1, a detailed description thereof is omitted.

However, the current collector 400 including the height adjustment member 414 differs in that it includes the variable resistance portion 430, and thus, unlike the current collector 300 including the height adjustment member 314, the amount of current flowing between the current collecting member 412 and the first coupling member 422 may be reduced when the temperature rises.

Hereinafter, a configuration of the cylindrical battery cell 1 according to an embodiment of the present disclosure will be described.

Referring to FIG. 1, the cylindrical battery cell 1 includes the electrode assembly 100, the can 200, the current collector 300, a cap 500, and an electrode terminal 600.

First, the electrode assembly 100 will be described.

As shown in FIG. 1, the electrode assembly 100 is an assembly of electrodes coated with an electrode active material and a separator, and may include a plurality of first electrodes 110 including the first electrode uncoated portion 111 in which a first electrode active material layer is not formed, and a plurality of second electrodes 120 alternately stacked with the plurality of first electrodes 110 with a separator 130 interposed therebetween.

Specifically, the first electrode 110 may serve as a first electrode and may be formed by coating a first electrode active material, such as graphite or carbon, on a first electrode current collector formed of a metal foil, such as copper or nickel.

The first electrode 110 includes the first electrode uncoated portion 111, which is a region on which the first electrode active material is not coated, and the first electrode uncoated portion 111 may be connected to the aforementioned current collector 300 or 400 to serve as a path for current flow between the first electrode 110 and an external device.

The second electrode 120 may serve as a second electrode and may be formed by coating a second electrode active material, such as a transition metal oxide, on a second electrode current collector formed of a metal foil, such as aluminum.

The second electrode 120 includes a second electrode uncoated portion 121, which is a region on which the second electrode active material is not coated, and the second electrode uncoated portion 121 may be connected to the electrode terminal 600 to be described below to serve as a path for current flow between the second electrode 120 and an external device.

The separator 130 may be positioned between the first electrode 110 and the second electrode 120 to prevent or mitigate a short circuit and to allow the migration of lithium ions. The separator 130 as described above may be formed of polyethylene, polypropylene, or a composite film of polyethylene and polypropylene.

Next, the can 200 will be described.

As shown in FIG. 1, the can 200 has an accommodation space formed therein, and may accommodate the electrode assembly 100 in the accommodation space through an opening formed at one side thereof.

The can 200 may have a cylindrical shape. Further, the can 200 may include aluminum or the like, but the material of the can 200 is not limited thereto.

Next, the current collector 300 or 400 will be described.

Because the current collector 300 or 400 is configured in the same manner as the current collector 300 according to the first embodiment of the present disclosure or the current collector 400 according to the second embodiment of the present disclosure as described above, a detailed description thereof is be omitted.

Next, the cap 500 will be described.

As shown in FIG. 1, the cap 500 may cover the opening of the can 200 to seal the accommodation space inside the can 200.

The cap 500 as described above may include the same material as the can 200, but the material of the cap 500 is not limited thereto.

Next, the electrode terminal 600 will be described.

As shown in FIG. 1, the electrode terminal 600 is installed at one side of the can 200 to be insulated from the can 200, and may be electrically connected to the plurality of second electrodes 120.

For example, the electrode terminal 600 may be electrically connected to a predetermined current collecting member, and the current collecting member may be electrically connected to the second electrode uncoated portion 121 of the second electrode 120, such that the electrode terminal 600 and the second electrode 120 may be electrically connected.

Hereinafter, the operation and effect of the current collector 300 or 400 and the cylindrical battery cell 1 according to an embodiment of the present disclosure will be described.

The current collector 300 includes the uncoated-portion contact portion 310 coupled to the first electrode uncoated portion 111 and the can contact portion 320 coupled to the can 200. The current collector 400 includes the uncoated-portion contact portion 410 coupled to the first electrode uncoated portion 111 and the can contact portion 420 coupled to the can 200.

The uncoated-portion contact portion 310 or 410 may include the same material as the first electrode uncoated portion 111, and the can contact portion 320 or 420 may include the same material as the can 200.

Thus, the uncoated-portion contact portion 310 or 410 may be easily welded to the first electrode uncoated portion 111, and the can contact portion 320 or 420 may be easily welded to the can 200.

In the current collector 400, the variable resistance portion 430 including a PTC material having a resistance that increases when the temperature increases is disposed at a portion at which the uncoated-portion contact portion 410 and the can contact portion 420 are coupled.

As the current collector 400 includes the variable resistance portion 430, the amount of a flow of current is reduced when the temperature increases, thereby enabling safe operation.

The cylindrical battery cell 1 includes the current collector 300 or 400.

Inside the cylindrical battery cell 1, the current collector 300 or 400 and the first electrode 110 are electrically connected, and the can 200 and the current collector 300 or 400 are also electrically connected.

Specifically, the uncoated-portion contact portion 310 or 410 of the current collector 300 or 400 may be coupled to the first electrode uncoated portion 111 of the first electrode 110 by welding or the like, and the can contact portion 320 or 420 of the current collector 300 or 400 may also be coupled to the can 200 by welding or the like.

The uncoated-portion contact portion 310 or 410 and the first electrode uncoated portion 111 may be easily welded to each other, and the can contact portion 320 or 420 and the can 200 may be easily welded to each other, such that the can 200 and the first electrode 110 are stably connected and the cylindrical battery cell 1 may stably supply power to an external device.

As described above, the current collector according to the present disclosure is configured such that the uncoated-portion contact portion includes the same material as the electrode uncoated portion, and the can contact portion includes the same material as the can, thereby facilitating welding of the uncoated-portion contact portion to the electrode uncoated portion and the can contact portion to the can.

Furthermore, the variable resistance portion including a PTC material is disposed at the portion at which the uncoated-portion contact portion and the can contact portion are coupled, and reduces the amount of a flow of current when the temperature rises, thereby preventing or mitigating the temperature of the current collector from continuously rising.

In addition, in the cylindrical battery cell according to the present disclosure, the current collector is stably welded to the electrode uncoated portion and the can, thereby capable of stably supplying power to an external device.

Furthermore, the current collector includes the variable resistance portion, and thus the temperature of the current collector is prevented or mitigated from continuously rising, thereby preventing or mitigating the cylindrical battery cell from thermal runaway.

The foregoing description of the present disclosure has been provided for illustrative purposes, and is not intended to be exhaustive or to limit the present disclosure to the precise forms disclosed. Those skilled in the art to which the present disclosure pertains will understand that various modifications can be easily made in other specific forms without departing from the technical spirit or essential characteristics of the present disclosure. Accordingly, the embodiments described herein should be understood in all respects as illustrative and not restrictive. For example, individual elements described as being provided in a single configuration may be implemented in a distributed manner, and similarly, elements described as being distributed may be implemented in a combined configuration.

The scope of the present disclosure is described by claims below rather than the Detailed Description as set forth above. The scope of the present disclosure should be construed as including not only the scope of the claims but also all changes or modifications derived from the meanings, the scope, and equivalents of the claims.

What is claimed is:

1. A current collector of a cylindrical battery cell, the current collector comprising:
an uncoated-portion contact portion, at least a portion of which is coupled to a first electrode uncoated portion of a first electrode of an electrode assembly of the cylindrical battery cell such that the uncoated-portion contact portion is electrically connected to the first electrode; and
a can contact portion coupled to the uncoated-portion contact portion to be electrically connected thereto, at least a portion of which contacts an inner circumferential surface of a can of the cylindrical battery cell such that the can contact portion is electrically connected to the can,
wherein the uncoated-portion contact portion includes the same material as the first electrode uncoated portion, and the can contact portion includes the same material as the can.

2. The current collector of claim 1, wherein the uncoated-portion contact portion comprises a current collecting member including an upper surface, a lower surface, and a side surface connecting the upper surface and the lower surface, and
wherein the can contact portion comprises a first coupling member having a hollow columnar shape extending in a longitudinal direction, and the first coupling member is coupled to an outer peripheral edge of the current collecting member to protrude from the outer peripheral edge of the current collecting member in a direction away from the upper surface.

3. The current collector of claim 2, wherein one end of the first coupling member in the longitudinal direction is coupled to an outer peripheral edge of the upper surface.

4. The current collector of claim 2, wherein an inner circumferential surface of the first coupling member is coupled to the side surface.

5. The current collector of claim 2, wherein the uncoated-portion contact portion further comprises a reinforcing member having a hollow columnar shape protruding from an outer peripheral edge of the upper surface in the direction away from the upper surface, and
wherein an inner circumferential surface of the first coupling member is coupled to the side surface and to an outer circumferential surface of the reinforcing member.

6. The current collector of claim 1, wherein the uncoated-portion contact portion comprises a current collecting member including an upper surface, a lower surface, and a side surface connecting the upper surface and the lower surface,
wherein the can contact portion comprises:
a first coupling member having a hollow columnar shape extending in a longitudinal direction; and
a second coupling member including a first surface, a second surface, and a third surface connecting the first surface and the second surface,
wherein the second surface of the second coupling member is coupled to the upper surface of the current collecting member, and
wherein the first coupling member extends from an outer peripheral edge of the second coupling member to protrude therefrom in a direction away from the first surface.

7. The current collector of claim 2, wherein the uncoated-portion contact portion further comprises one or more height adjustment members extending from the lower surface to form an acute angle with the lower surface, and
wherein the first electrode uncoated portion is coupled to the height adjustment member.

8. A current collector of a cylindrical battery cell, the current collector comprising:
an uncoated-portion contact portion, at least a portion of which is coupled to a first electrode uncoated portion of a first electrode of an electrode assembly of the cylindrical battery cell such that the uncoated-portion contact portion is electrically connected to the first electrode;
a can contact portion coupled to the uncoated-portion contact portion to be electrically connected thereto, at least a portion of which contacts an inner circumferential surface of a can of the cylindrical battery cell such that the can contact portion is electrically connected to the can; and
a variable resistance portion including a Positive Temperature Coefficient (PTC) material having a resistance that increases by a predetermined magnitude or more when a temperature reaches or exceeds a predetermined temperature, and disposed at a portion at which the uncoated-portion contact portion and the can contact portion are coupled such that a portion of the variable resistance portion contacts the uncoated-portion contact portion and a remaining portion thereof contacts the can contact portion,
wherein the can contact portion includes the same material as the can and the uncoated-portion contact portion includes the same material as the first electrode uncoated portion.

9. The current collector of claim 8, wherein the uncoated-portion contact portion comprises a current collecting member including an upper surface, a lower surface, and a side surface connecting the upper surface and the lower surface, and
wherein the can contact portion comprises a first coupling member having a hollow columnar shape extending in a longitudinal direction, and the first coupling member is coupled to an outer peripheral edge of the current collecting member with the variable resistance portion interposed therebetween such that the first coupling member protrudes from the outer peripheral edge of the current collecting member in a direction away from the upper surface.

10. The current collector of claim 9, wherein one end of the first coupling member in the longitudinal direction is coupled to an outer peripheral edge of the upper surface with the variable resistance portion interposed therebetween.

11. The current collector of claim 9, wherein an inner circumferential surface of the first coupling member is coupled to the side surface with the variable resistance portion interposed therebetween.

12. The current collector of claim 9, wherein the uncoated-portion contact portion further comprises a reinforcing member having a hollow columnar shape protruding from an outer peripheral edge of the upper surface in the direction away from the upper surface, and
wherein an inner circumferential surface of the first coupling member is coupled to the side surface and to an outer circumferential surface of the reinforcing member with the variable resistance portion interposed therebetween.

13. The current collector of claim 8, wherein the uncoated-portion contact portion comprises a current collecting member including an upper surface, a lower surface, and a side surface connecting the upper surface and the lower surface,
wherein the can contact portion comprises:
a first coupling member having a hollow columnar shape extending in a longitudinal direction; and
a second coupling member including a first surface, a second surface, and a third surface connecting the first surface and the second surface,
wherein the second surface of the second coupling member is coupled to the upper surface of the current collecting member with the variable resistance portion interposed therebetween, and
wherein the first coupling member extends from an outer peripheral edge of the second coupling member to protrude therefrom in a direction away from the first surface.

14. The current collector of claim 9, wherein the uncoated-portion contact portion further comprises one or more height adjustment members extending from the lower surface to form an acute angle with the lower surface, and
wherein the first electrode uncoated portion is coupled to the height adjustment member.

15. A cylindrical battery cell comprising:
an electrode assembly comprising:
a plurality of first electrodes including a first electrode uncoated portion in which a first electrode active material layer is not formed; and
a plurality of second electrodes alternately stacked with the plurality of first electrodes with a separator interposed therebetween;
a can having a cylindrical shape, having an accommodation space formed therein, and accommodating the electrode assembly in the accommodation space through an opening formed at one side thereof;
the current collector of claim 1;
a cap covering the opening to seal the accommodation space; and
an electrode terminal installed at one side of the can to be insulated from the can, and electrically connected to the plurality of second electrodes.
